(19) United States
(12) Patent Application Publication
(10) Pub. No.: US 2025/0295150 A1
(43) Pub. Date: Sep. 25, 2025

(54) CHARCUTERIE OF THE SLICED HAM AND SAUSAGE TYPE WITH VARIABLE ANIMAL PROTEIN CONTENT AND THE PROCESS FOR ITS PREPARATION

(71) Applicant: Walberto Noe García Aguilera, Ciudad de México (MX)

(72) Inventor: Walberto Noe García Aguilera, Ciudad de México (MX)

(21) Appl. No.: 19/079,739

(22) Filed: Mar. 14, 2025

(30) Foreign Application Priority Data
Mar. 19, 2024 (MX) MX/A/2024/003429

(51) Int. Cl. A23L 13/50; A22C 11/00; A23L 5/10; A23L 13/60; A23L 29/212

(52) U.S. Cl. CPC A23L 13/52; A22C 11/00; A23L 5/10; A23L 13/65; A23L 29/212

(57) ABSTRACT

A sausage formulation, characterized in that it comprises: Corn starch (20-30%), Modified corn starch (20-30%), Water (30-40%), Animal protein (20-30%), Salt (1-3%), Preservative (1-3%).

### CROSS REFERENCE TO RELATED APPLICATION

This application claims the benefit of co-pending Mexican Application No. MX/a/2024/003429 entitled “CHARCUTERIE OF THE SLICED HAM AND SAUSAGE TYPE WITH VARIABLE ANIMAL PROTEIN CONTENT AND THE PROCESS FOR ITS PREPARATION” filed Mar. 19, 2024, which is incorporated herein by reference.

### FIELD OF THE INVENTION

The technical field of the instant disclosure relates to the food industry and, more particularly, to charcuterie of the sliced ham and sausage type with variable content of animal protein and process of preparation thereof.

### BACKGROUND

Korean Patent Publication No. KR102443936 B1 describes a method of ham processing comprising the stages of shaping the meat, vacuum packing of the liquefied meat and salting; netting the liquefied meat for cooking in smoking; cooling the mixed meat in netting; untangling of the mixed meat and refrigerated storage; additionally comprising the stage of detecting the content of metals in the liquefied meat, the auxiliary material is characterized in that it contains stevioside.

Chinese Patent Publication No. CN114472443 A describes a technology for producing low-salt ham with temperature and humidity control under closed conditions, the technology is complete with a ham aeration processing device and an outer casing.

Chinese Patent Publication No. CN113424928 A describes a process for the production of patterned cooked ham slices.

Chinese Patent Publication No. CN111493289 A describes a process for making ham comprising the following steps: pretreatment of raw meat; addition and mixing of additives; marinating of the mixture; molding of the mixture; cooking of the mixture from 80-86° C.; cooling and storage.

The above-described publications do not disclose sliced ham and sausage with variable animal protein content is provided. Accordingly, there is a need for an improvement.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a formulation of sliced ham and sausage with variable animal protein content is disclosed.

In other implementations, a process of preparation of sliced ham and sausage with variable animal protein content.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 illustrates a flow diagram of sliced ham in its economic category.

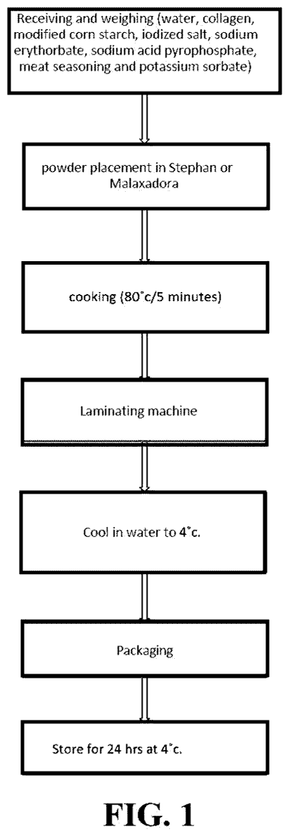

FIG. 2 illustrates a process flow diagram for preparing sausage

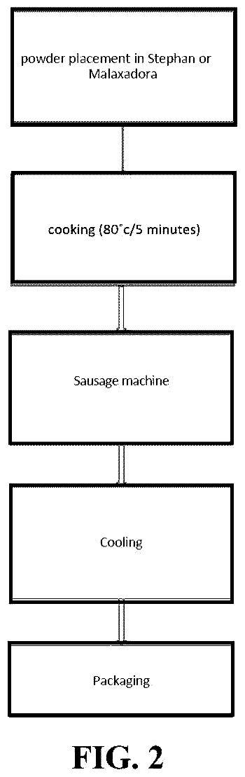

### DETAILED DESCRIPTION

In one embodiment of the present invention, a formulation of sliced ham and sausage with variable animal protein content is provided.

Animal protein is selected from meat: turkey, pork and chicken.

In another embodiment of the present invention the sliced ham and sausage may lack animal muscle protein.

The invention describes a formula and process for the preparation of a sliced ham very similar to that of a yellow cheese in individual slices.

The ham is prepared from the following ingredients that make up the dough: Corn starch (20-30%), Modified corn starch (20-30%), Water (30-40%), Animal protein (20-30%), Salt (1-3%), Preservative (1-3%). Unless otherwise indicated herein, all percentages refer to weight percentages.

The preparation process comprises the following steps:
1. —Weighing of ingredients. The addition of meat protein of any origin will depend on the quality of the final product, since the formula works well without any muscle meat protein.
2. —They are placed in Stephan or Stephan type or Malaxadora malaxing or cutting, mixing and heating food processing machine, preferably with screws.
3. —They are mixed while the temperature is increased until reaching 85° C.
4. —Subsequently the dough can be sent directly to the laminating machine or placed in a container that feeds the laminating machine.
5. —The laminate is made according to the size and thickness that the manufacturer requires depending on the needs of its market.
6. —Once the laminate is made, it is passed through a tub of cold water at a temperature of 4-8° C. in order to reach a firm consistency.
7. —The laminates can be packaged in 10-piece bags or cartons according to the manufacturer's requirements.

Ham-type sausage without muscle meat protein can achieve a shelf life of at least one month outside of refrigeration, while ham-type sausage or ham with additional meat protein to the formula such as chicken, turkey or pork will need to be kept refrigerated.

1-7. (canceled)

8: A formulation comprising:
between about 20% to about 30% corn starch;
between about 20% to about 30% modified corn starch;
between about 30% to about 40% water;
between about 20% to about 30% animal protein;
between about 1% to about 3% salt; and
between about 1% to about 3% preservative.

9: The formulation of claim 8, wherein the formulation is a meat selected from group consisting of sausage and sliced ham.

10: The formulation of claim 9, wherein the animal protein is a protein selected from the group consisting of turkey, pork, and chicken.

11: The formulation of claim 8, wherein the animal protein is a protein selected from the group consisting of turkey, pork, and chicken.

12: The formulation of claim 8, wherein the animal protein does not include muscle protein.

13: The formulation of claim 9, wherein the animal protein does not include muscle protein.

14: The formulation of claim 10, wherein the animal protein does not include muscle protein.

15: The formulation of claim 11, wherein the animal protein does not include muscle protein.

16: A method for preparing charcuterie having ingredients including between about 20% to about 30% corn starch, between about 20% to about 30% modified corn starch, between about 30% to about 40% water, between about 20% to about 30% animal protein, between about 1% to about 3% salt, and between about 1% to about 3% preservative, the method comprising:
weighing the ingredients to ensure that the amount of animal protein corresponds to an amount of animal protein that does not contain muscle meat;
placing the ingredients in a heated food processing machine selected from the group consisting of a malaxing food processing machine and a cutting, mixing and heating food processing machine;
mixing the ingredients within the heated food processing machine until the heated food processing machine reaches a temperature of about 85° C. to form a heated mass;
sending the heated mass directly to a stuffing machine to form a sausage product;
cooling the sausage product to a temperature of about 4° C.; and
placing the sausage product in a refrigeration chamber for 24 hours to reach a final consistency.

17: The method of claim 16, further comprising:
packaging the sausage product.

18: The method of claim 16, wherein the animal protein is selected from the group consisting of turkey, pork, and chicken.
